(19) United States
(12) Patent Application Publication
(10) Pub. No.: US 2025/0289928 A1
(43) Pub. Date: Sep. 18, 2025

(54) HIGH HEAT DEFLECTION TEMPERATURE PHOTOCURABLE RESIN

(71) Applicant: BASF SE, Ludwigshafen am Rhein (DE)

(72) Inventors: Elvira STESIKOVA, Wyandotte, MI (US); Mark Andrew GOETSCH, Wyandotte, MI (US)

(21) Appl. No.: 18/270,872

(22) PCT Filed: Jan. 5, 2022
(86) PCT No.: PCT/US2022/011331

§ 371 Date: Jul. 5, 2023

Related U.S. Application Data
(60) Provisional application No. 63/134,295, filed on Jan. 6, 2021.

(51) Int. Cl. C08G 71/04

(52) U.S. Cl. CPC C08G 71/04; C08G 2330/00

(57) ABSTRACT

Described herein are photopolymerizable compositions for use in 3D printing. The compositions contain highly crosslinkable acrylate monomers, elastic urethane acrylate oligomers, photoinitiator and optionally carbon black. The compositions, after photopolymerization, have a high heat deflection temperature (for example, at least 80C), while maintaining strong mechanical properties, such as E modulus, tensile strength, and elongation at break. Also described are methods for fabricating three dimensional objects utilizing these compositions, and three dimensional objects made from these compositions.

### CROSS REFERENCE TO RELATED APPLICATIONS

This application claims the benefit of U.S. Provisional Patent Application No. 63/134,295, filed Jan. 6, 2021, which is imported herein by reference in its entirety.

### TECHNICAL FIELD

The present disclosure relates to three dimensional (3D) printing technology, and, more specifically, it is related to 3D printable compositions for inkjet, stereolithography (SLA), and Digital Light Processing (DLP), and methods of use and preparation thereof.

### BACKGROUND OF THE INVENTION

In the discussion of the background that follows, reference is made to certain structures and/or methods. However, the following references should not be construed as an admission that these structures and/or methods constitute prior art. Applicant expressly reserves the right to demonstrate that such structures and/or methods do not qualify as prior art.

Photocurable compositions are materials used in 3D printing techniques using light source(s) to cure (polymerize) a network of a monomer and oligomer, initiating radical polymerization using a photoinitiator. Generally, these compositions contain photoinitiators, monomers, oligomers, and other components.

In the past three decades, the focus of the stereolithographic (SLA) and Digital Light Processing (DLP) 3D printing industry was centered on prototyping and limited manufacturing opportunities. Over that time, substantial advancements were made in the development of 3D printers, software and towards embracing open systems. Unfortunately, the development of advanced materials for SLA and DLP applications lagged due to prevalence of closed systems and lack of technical requirements for prototyping. Now that the additive manufacturing industry is steadily evolving from prototyping to manufacturing it is critical to have advanced materials with specific properties dictated by targeted and well-defined applications. Thus, it becomes paramount to develop elastomers and thermoplastic 3D printable materials with advanced performance specifications that could match existing manufacturing technologies such as injection molding and traditional fabrication methods.

There remains a desire to provide 3D printing formulations which balance desirable physical properties such as hardness and elongation, but also demonstrate improved thermal stability. More specifically, there is a desire to combine workable physical characteristics (impact strength, elasticity modulus, and elongation at break) with sufficiently high heat deflection temperature (“HDT”). By balancing these factors the goal is to provide a strong material that resists impact and deformation at elevated temperatures, possesses mechanical stability, and is tough. Heat deflection temperature is a measure of a polymer's resistance to distortion under a given load at elevated temperature. The test reports the temperature at which a given test bar will be deflected of 0.25 mm under a given load. In certain applications, for example in electronics devices or automotive applications, a 3D printed device needs to have some resistance to physical changes based on temperature (high heat resistance), while also maintaining appropriate physical characteristics. The goal of the instant invention was to find a formulation that could reproducibly be 3D printed to form devices that have adequate strength for these applications, while also seeking to increase the heat deflection temperature.

It was surprisingly found that with the use of particular highly crosslinkable acrylate monomers, with two functional groups or more capable of crosslinking, in particular four functional groups or more, in combination with an elastic urethane acrylate oligomer, it was possible to create formulations that provided 3D printed scaffolds that exhibited heightened HDT, while maintaining physical characteristics, such as strength, that rendered the compositions useful in high temperature applications, such as electronics and automotive.

### BRIEF SUMMARY OF THE INVENTION

One aspect of the present technology relates to a composition which includes one or more highly crosslinkable monomers with at least three functional groups, for example at least four functional groups, in particular four to six functional groups; and at least one elastic oligomer, wherein the composition is a 3D UV curable composition. The highly crosslinkable monomers useable with the instant invention may have high T_{g} values, for example greater than 100° C., in particular greater than 150° C. The elastomeric oligomers may, for example, be long chain diacrylate polyurethane oligomers.

In another aspect of the present technology, the composition contains the one or more highly crosslinkable monomers and the at least one elastic oligomer in a weight ratio of 20:80 to 80:20, for example 30:70 to 70:30, for example 60:40 to 70:30.

In another aspect of the present technology, the composition has a heat deflection temperature of at least 80° C., for example at least 100° C., in particular at least 200° C.

In another aspect of the present technology the 3D UV curable composition contains Ethoxylated Pentaerythriol Tetracrylate as highly crosslinkable monomer and a urethane acrylate oligomer.

In any embodiments, the compositions may be useful for inkjet, SLA, and/or DLP deposition. In any embodiments, the composition may include one or more photoinitiators. The present technology also provides a package that includes any of the compositions described herein.

In another aspect, the present technology relates to a method for preparing a 3D article using the compositions described in any embodiment herein, the method includes applying successive layers of one or more of the compositions described herein in any embodiment to fabricate a 3D article; and irradiating the successive layers with UV irradiation. In any embodiments, the composition may be inkjet, SLA, and/or DLP deposited. These successive layers may have a thickness from 50 to 200 μm. Thicker layers may allow for faster printing, while thinner layers may result in better resolution.

In yet another related aspect, the present technology provides a 3D article that includes UV cured successive layers of any of the compositions described herein. In any embodiments, the compositions may be deposited by inkjet, SLA, or DLP.

### Definitions

Prior to describing the invention in further detail, the terms used in this application are defined as follows unless otherwise indicated.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

“Optional” or “optionally” means that the subsequently described circumstance may or may not occur, so that the description includes instances where the circumstance occurs and instances where it does not.

The term “pre-determined” refers to an element whose identity is known prior to its use.

As used herein, the term “Stereolithography” or “SLA” refers to a form of 3D printing technology used for creating models, prototypes, patterns, and production of parts in a layer-by-layer fashion using photopolymerization, a process by which light causes chains of molecules to link, forming polymers. Those polymers then make up the body of a three-dimensional solid.

As used herein, the term “Digital Light Processing” or “DLP” refers to an additive manufacturing process, also known as 3D printing and similar to stereolithography, which takes a design created in a 3D modeling software and uses DLP technology to print a 3D object. DLP is a display device based on optical micro-electro-mechanical technology that uses a digital micromirror device. DLP may use as a light source in printers to cure resins into solid 3D objects.

As used herein, the term “Heat Deflection Temperature” or “HDT” is a measure of a polymer's resistance to distortion under a given load at elevated temperature. In other words, it is the temperature at which a given polymer test bar will be deflected by 0.25 mm under a given load. This heat deflection temperature may also be known as “deflection temperature under load,” or “heat distortion temperature.” It is tested in accordance with ASTM D 648.'

### EMBODIMENTS OF THE INVENTION

In a first embodiment, a photopolymerizable composition comprising:
at least one highly crosslinkable acrylate monomer with a functionality of 3 or higher;
at least one elastic urethane acrylate oligomer; and
at least one photoinitiator.

A second embodiment is the photopolymerizable composition according to the first embodiment, wherein the at least one highly crosslinkable acrylate monomer is an acrylate monomer according to Formula I:

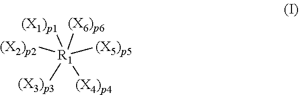

wherein R₁ is a branched or linear hydrocarbon chain with carbon, ether, ester or urethane linkages; each of X₁, X₂, X₃, X₄, X₅, and X₆ is independently an acryl moiety, and each of p₁, p₂, p₃, p₄, p₅, and p₆ is independently 0 or 1; wherein the sum of p₁, p₂, p₃, p₄, p₅, and p₆ is a value of from 3 to 6.

A third embodiment is the photopolymerizable composition according to the second embodiment, wherein the sum of p₁, p₂, p₃, p₄, p₅, and p₆ is a value of from 4 to 5.

A fourth embodiment is the photopolymerizable composition according to the first embodiment, wherein the at least one highly crosslinkable acrylate monomer is an acrylate monomer according to Formula II:

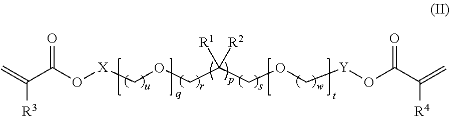

wherein R¹ and R² are each independently H, C₁₋₆ alkyl, or

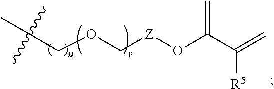

wherein at least one R¹ or R² is

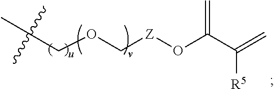

R³, R⁴, and R⁵ are each independently H or CH₃;
X, Y, and Z are independently absent or a C₁-C₆ alkylene group;
p is 0 or 1;
w at each occurrences is independently 1, 2, or 3;
q is 0 or an integer from 1-100;
t is 0 or an integer from 1-100;
r, s, u, and v are independently 0, 1, 2, 3, or 4.

A fifth embodiment is the photopolymerizable composition according to the fourth embodiment wherein both R¹ and R² are

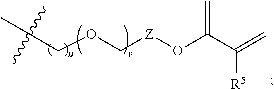

A sixth embodiment is the photopolymerizable composition according to any of the first five embodiments, wherein the at least one highly crosslinkable acrylate monomer is selected from the group consisting of:

Ethoxylated pentaerythritol tetraacrylate

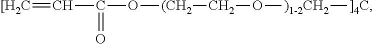

Ethoxylated trimethyl propane triacrylate

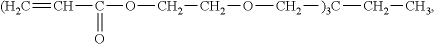

Propoxylated glycerol triacrylate

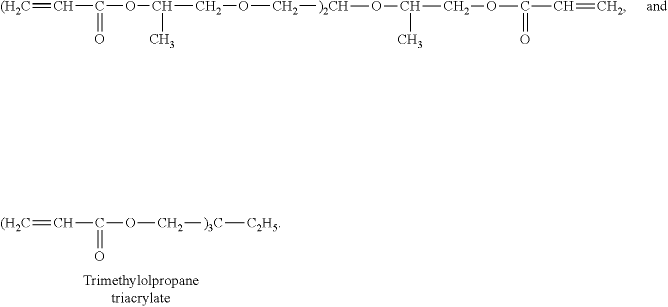

A seventh embodiment is the photopolymerizable composition according to any of the first six embodiments, wherein the highly crosslinkable acrylate monomer is ethoxylated pentaerythritol tetraacrylate.

An eighth embodiment is the photopolymerizable composition according to any one of the first seven embodiments, wherein the elastic urethane acrylate oligomer is a urethane(meth)acrylate of formula (III)

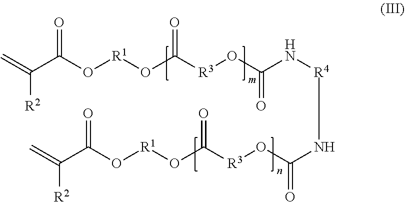

wherein:
R¹ is a divalent alkylene radical which has 2 to 12 carbon atoms and which may optionally be substituted by C₁ to C₄ alkyl groups and/or interrupted by one or more oxygen atoms, said radical specifically having 2 to 10 carbon atoms, more specifically 2 to 8, and very specifically having 3 to 6 carbon atoms,
R² in each case independently of any other is methyl or hydrogen, specifically hydrogen,
R³ is a divalent alkylene radical which has 1 to 12 carbon atoms and which may optionally be substituted by C₁ to C₄ alkyl groups and/or interrupted by one or more oxygen atoms, said radical having specifically 2 to 10, more specifically 3 to 8, and very specifically 3 to 4 carbon atoms, and
n and m independently of one another are positive numbers from 1 to 5, specifically 2 to 5, more specifically 2 to 4, very specifically 2 to 3, and more particularly 2 to 2.5.

R⁴ here is a divalent organic radical which is formed by abstraction of both isocyanate groups from an aliphatic, cycloaliphatic or aromatic diisocyanate.

A ninth embodiment is the photopolymerizable composition according to the eighth embodiment, wherein the urethane acrylate oligomer is obtained by a process comprising:

(I) reacting hydroxyalkyl(meth)acrylates (A) of the formula

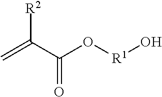

with (n+m)/2 equivalents of lactone (B) of formula

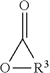

to form an intermediate of formula

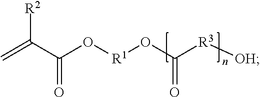

and

(II) reacting the intermediate formed in the first step with at least one aliphatic, cycloaliphatic or aromatic diisocyanate to form the urethane acrylate oligomer.

A tenth embodiment is the photopolymerizable composition according to the ninth embodiment, wherein the hydroxyalkyl(meth)acrylate (A) is selected from the group consisting of 2-hydroxyethyl(meth)acrylate, 2- or 3-hydroxypropyl(meth)acrylate, 1,4-butanediol mono(meth)acrylate, neopentyl glycol mono(meth)acrylate, 1,5-pentanediol mono(meth)acrylate, and 1,6-hexanediol mono(meth)acrylate, very specifically 2-hydroxyethyl(meth)acrylate, 2-hydroxypropyl(meth)acrylate, and 1,4-butanediol mono(meth)acrylate.

An eleventh embodiment is the photopolymerizable composition according to the tenth embodiment, wherein the hydroxyalkyl(meth)acrylate (A) is hydroxyethyl(meth)acrylate.

A twelfth embodiment is the photopolymerizable composition according to any one of the ninth to eleventh embodiment, wherein the lactone (B) is selected from the group consisting of beta-propiolactone, gamma-butyrolactone, gamma-ethyl-gamma-butyrolactone, gamma-valerolactone, delta-valerolactone, epsilon-caprolactone, 7-methyloxepan-2-one, 1,4-dioxepan-5-one, oxacyclotridecan-2-one, and 13-butyl-oxacyclotridecan-2-one.

A thirteenth embodiment is the photopolymerizable composition according to the twelfth embodiment, wherein the lactone (B) is epsilon-caprolactone.

A fourteenth embodiment is the photopolymerizable composition according to any one of the ninth through thirteenth embodiments, wherein the at least one aliphatic, cycloaliphatic or aromatic diisocyanate is dicyclomethane diisocyanate.

A fifteenth embodiment is the photopolymerizable composition according to any one of the first through fourteenth embodiments, wherein the composition contains the at least one highly crosslinkable acrylate monomer and the at least one elastic urethane acrylate oligomer in a weight ratio of 20:80 to 80:20.

A sixteenth embodiment is the photopolymerizable composition according to any one of the first through fifteenth embodiments, wherein the composition contains the at least one highly crosslinkable acrylate monomer and the at least one elastic urethane acrylate oligomer in a weight ratio of 30:70 to 70:30.

A seventeenth embodiment is the photopolymerizable composition according to any one of the first through fourteenth embodiments, wherein the composition contains the at least one highly crosslinkable acrylate monomer and the at least one elastic urethane acrylate oligomer in a weight ratio of 60:40 to 70:30.

An eighteenth embodiment is the photopolymerizable composition according to any one of the fifteenth through seventeenth embodiments, wherein the one or more highly crosslinkable monomers is present in an amount of from 60 to 75 wt %, and the at least one elastic urethane acrylate oligomer is present in an amount of 10 to 40 wt %, both based on the composition as a whole.

A nineteenth embodiment is the photopolymerizable composition according to the eighteenth embodiment, wherein the at least one elastic urethane acrylate oligomer is present in an amount of 20 to 30 wt %

A twentieth embodiment is the photopolymerizable composition according to any one of the first through fourteen embodiments, further comprising carbon black and wherein the weight ratio of the at least one highly crosslinkable acrylate monomer and the at least one elastic urethane acrylate oligomer is in the range of 65:35 to 75:25.

A twenty-first embodiment is the photopolymerizable composition according to any one of the first through twentieth embodiments, wherein the composition, after photopolymerization, has a heat deflection temperature of at least 80° C.

A twenty-second embodiment is the photopolymerizable composition according to the twenty-first embodiment, wherein the composition, after photopolymerization, has a heat deflection temperature of at least 150° C.′

A twenty-third embodiment is a package comprising the composition of any one of the first through twenty-second embodiments.

A twenty-fourth embodiment is a method of preparing a three-dimensional article, wherein the method comprises applying successive layers of one or more of the compositions of any one of the first through twenty-second embodiments to fabricate a three-dimensional article, and irradiating the successive layers with UV irradiation.

A twenty-fifth embodiment is the method of the twenty-fourth embodiment, wherein the applying comprises depositing a first layer of the composition to a substrate and applying a second layer of the composition to the first layer and optionally applying successive layers thereafter.

A twenty-sixth embodiment is the method of the twenty-fourth or twenty-fifth embodiment, wherein the applying comprises ink jet printing of the composition.

A twenty-seventh embodiment is the method of any one of the twenty-fourth through twenty-sixth embodiments, wherein the three-dimensional article has a heat deflection temperature of at least 100° C.

A twenty-eighth embodiment is the method of any one of the twenty-fourth through twenty-seventh embodiment, wherein the three-dimensional article has a heat deflection temperature of at least 150° C.′

A twenty-ninth embodiment is a three-dimensional article comprising UV cured successive layers of the composition of any one of the first through twenty-second embodiments.

A thirtieth embodiment is a three-dimensional article produced by the method of any one of the twenty-fourth through twenty-eighth embodiments.

A thirty-first embodiment is the three-dimensional article of the twenty-ninth or thirtieth embodiment, wherein the three dimensional article has a heat deflection temperature of at least 100° C.

A thirty-second embodiment is the three-dimensional article of the twenty-ninth or thirtieth embodiment, wherein the three dimensional article has a heat deflection temperature of at least 150° C.

### DETAILED DESCRIPTION OF THE INVENTION

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

Disclosed is a composition for use in three dimensional printing by way of photopolymerization.

Provided herein are UV curable compositions containing, as monomer, a highly crosslinkable monomer with Tg or softening point of at least 100° C. As is the case with highly crosslinkable monomers, the Tg values could be assessed using a variety of analytical methods. Herein was used Dynamic Mechanical Analysis (DMA) to measure softening point using the same loading of 455 kPa as in the HDT test. Monomers used herein have a softening point of at least 100° C., for example at least 150° C. In one embodiment, the highly crosslinkable monomer is an acrylate monomer according to Formula I:

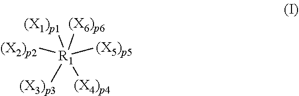

wherein R₁ is a branched or linear hydrocarbon chain with carbon, ether, ester or urethane linkages; each of X₁, X₂, X₃, X₄, X₅, and X₆ is independently an acryl moiety, and each of p₁, p₂, p₃, p₄, p₅, and p₆ is independently 0 or 1; wherein the sum of p₁ though p₆ is a value of from 2 to 6, for example 4 to 6, for example 4 or 5.

In one embodiment, the highly crosslinkable monomer is an acrylate monomer according to Formula II:

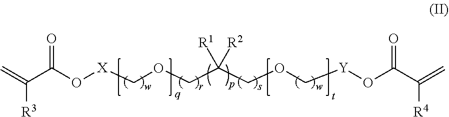

Wherein R¹ and R² are each independently H, C₁₋₆ alkyl, or

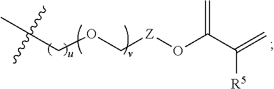

and wherein at least one R¹ or R² is

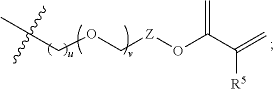

R³, R⁴, and R⁵ are each independently H or CH₃;
X, Y, and Z are independently absent or a C₁-C₆ alkylene group;
p is 0 or 1;
w at each occurrences is independently 1, 2, or 3;
q is 0 or an integer from 1-100;
t is 0 or an integer from 1-100;
r, s, u, and v are independently 0, 1, 2, 3, or 4.

In an embodiment, the highly crosslinkable monomer is an acrylate monomer according to Formula II, wherein at least one of R¹ and R² is

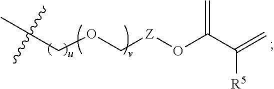

In another embodiment, the highly crosslinkable monomer is an acrylate monomer according to Formula II, wherein both R¹ and R² are

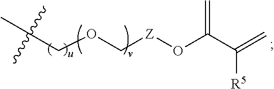

In another embodiment, the highly crosslinkable monomer has a high T_{g}, in particular a T_{g} greater than equal to 100° C., for example greater than equal to 150° C., in particular greater than or equal to 200° C.

In another embodiment, the highly crosslinkable monomer is an acrylate monomer selected from the group consisting of a urethane acrylate with functionality of 6, sold for example as Arkema SARTOMER CN968,

Ethoxylated pentaerythritol tetraacrylate

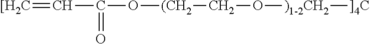

Ethoxylated trimethyl propane triacrylate

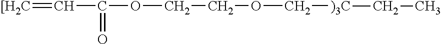

Propoxylated glycerol triacrylate

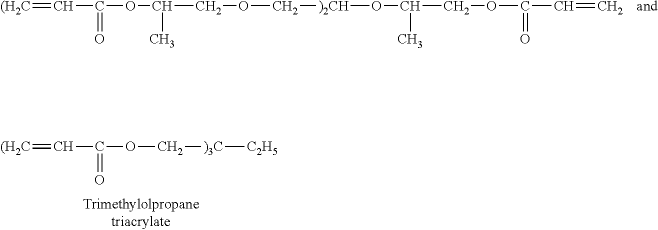

each of which may optionally contain additives to reinforce mechanical and thermal stability, such as silica nanoparticles. In particular, the highly crosslinkable monomer is ethoxylated pentaerythritol tetraacrylate.

In the photopolymerizable 3D printing compositions disclosed herein, the highly crosslinkable monomer is used in combination with an elastic urethane acrylate oligomer. Such oligomers have higher molecular weight flexible chains to offset brittleness and impart elasticity. These oligomers are, for example, long chain diacrylate polyurethane oligomers.

In one embodiment, the urethane acrylate oligomer is a urethane(meth)acrylate of formula (III)

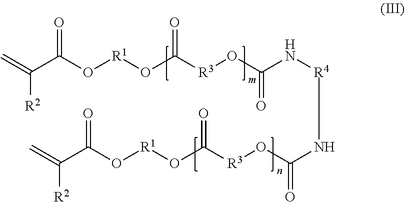

In the above formula,
R¹ is a divalent alkylene radical which has 2 to 12 carbon atoms and which may optionally be substituted by C₁ to C₄ alkyl groups and/or interrupted by one or more oxygen atoms, said radical specifically having 2 to 10 carbon atoms, more specifically 2 to 8, and very specifically having 3 to 6 carbon atoms,
R² in each case independently of any other is methyl or hydrogen, specifically hydrogen,
R³ is a divalent alkylene radical which has 1 to 12 carbon atoms and which may optionally be substituted by C₁ to C₄ alkyl groups and/or interrupted by one or more oxygen atoms, said radical having specifically 2 to 10, more specifically 3 to 8, and very specifically 3 to 4 carbon atoms, and
n and m independently of one another are positive numbers from 1 to 5, specifically 2 to 5, more specifically 2 to 4, very specifically 2 to 3, and more particularly 2 to 2.5.

R⁴ here is a divalent organic radical which is formed by abstraction of both isocyanate groups from an aliphatic, cycloaliphatic or aromatic diisocyanate. Methods of making such urethane acrylate oligomers may be found, for example, in US 2016/0107987, the contents of which are incorporated herein by reference.

Such urethane acrylate oligomers can be made, for example, by reacting hydroxyalkyl(meth)acrylates (A) of the formula

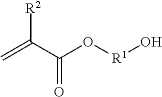

in which R¹ and R² have the definitions set out above with (n+m)/2 equivalents of lactone (B) of formula

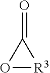

in which R³ has the definitions set out above. This reaction results in an intermediate of formula

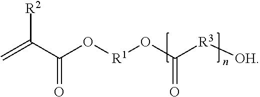

Exemplary hydroxyalkyl(meth)acrylates (A) are selected from 2-hydroxyethyl(meth)acrylate, 2- or 3-hydroxypropyl(meth)acrylate, 1,4-butanediol mono(meth)acrylate, neopentyl glycol mono(meth)acrylate, 1,5-pentanediol mono(meth)acrylate, and 1,6-hexanediol mono(meth)acrylate, very specifically 2-hydroxyethyl(meth)acrylate, 2-hydroxypropyl(meth)acrylate, and 1,4-butanediol mono(meth)acrylate, and especially 2-hydroxyethyl(meth)acrylate. Particular exemplary hydroxyalkyl(meth)acrylates are hydroxyethyl(meth)acrylate, in particular beta-hydroxyethyl acrylate.

Exemplary lactones (B) are selected from beta-propiolactone, gamma-butyrolactone, gamma-ethyl-gamma-butyrolactone, gamma-valerolactone, delta-valerolactone, epsilon-caprolactone, 7-methyloxepan-2-one, 1,4-dioxepan-5-one, oxacyclotridecan-2-one, and 13-butyl-oxacyclotridecan-2-one. A particular exemplary lactone is epsilon-caprolactone.

In a second step, the intermediate formed in the first step is reacted with at least one aliphatic, cycloaliphatic or aromatic diisocyanate to form the urethane acrylate oligomer. Exemplary diisocyanates include dicyclomethane diisocyanate, in particular dicyclohexylmethane-4,4′-diisocyanate. In exemplary urethane acrylate oligomer is obtained by reacting beta-hydroxyethyl acrylate with epsilon-caprolactone, then reacting with dicyclohexylmethane-4,4′-diisocyanate.

In another embodiment, the urethane acrylate oligomer is at least one high strength and high flexibility urethane(meth)acrylate having a molar mass M_{w} of 1000 to 5000 g/mol and two ethylenically unsaturated double bonds per molecule, comprising as synthesis components
(a1) at least one aromatic or cycloaliphatic diisocyanate,
(a2) at least one polyesterdiol synthesized from
(a21) optionally a diol having a molar weight below 250 g/mol,
(a22) at least one oligomeric or polymeric diol selected from the group consisting of
(a221) polytetrahydrofurandiol with a molar mass Mn of up to 1000 g/mol and
(a222) at least one poly caprolactonediol with a molar mass Mn of up to 600 g/mol,
(a23) at least one dicarboxylic acid selected from the group consisting of compounds of the formula (Ia)

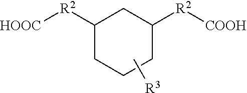

and/or compound of the formula (Ib)

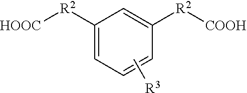

wherein R² is a single bond or a divalent alkylene radical comprising 1 to 3 carbon atoms, and
R³ is hydrogen or an alkyl radical comprising 1 to 10 carbon atoms, and

(a3) a third compound comprising precisely one isocyanate-reactive group and precisely one free polymerizable group.

Exemplary aromatic diisocyanates include aromatic diisocyanates such as 2,4- or 2,6-tolylene diisocyanate and the isomer mixtures thereof, m- or p-xylylene diisocyanate, 2,4′- or 4,4′-diisocyanatodiphenylmethane and the isomer mixtures thereof, 1,3- or 1,4-phenylene diisocyanate, 1-chloro-2,4-phenylene diisocyanate, 1,5-naphthylene diisocyanate, diphenylene 4,4′-diisocyanate, 4,4′-diisocyanato-3,3′-dimethylbiphenyl, 3-methyldiphenylmethane 4,4′-diisocyanate, tetramethylxylylene diisocyanate, 1,4-diisocyanatobenzene or diphenyl ether 4,4′-diisocyanate.

Exemplary cycloaliphatic diisocyanates include ,4-, 1,3- or 1,2-diisocyanatocyclohexane, 4,4′- or 2,4′-di(isocyanatocyclohexyl)methane, 1-isocyanato-3,3,5-trimethyl-5-(isocyanatomethyl)cyclohexane(isophorone diisocyanate), 1,3- or 1,4-bis(isocyanatomethyl)cyclohexane or 2,4- or 2,6-diisocyanato-1-methylcyclohexane, and also 3 (or 4), 8 (or 9)-bis(isocyanatomethyl)tricyclo[5.2.1.0^{2,6}]decane isomer mixtures.

Further exemplary urethane acrylate oligomers are polyurethane acrylates which substantially comprise as components:
(a) at least one organic aliphatic, aromatic or cycloaliphatic di- or polyisocyanate,
(b) at least one compound having at least one group reactive toward isocyanate and at least one unsaturated group capable of free radical polymerization and
(c) optionally at least one compound having at least two groups reactive toward isocyanate.

Aliphatic, aromatic, and cycloaliphatic di- and polyisocyanates have an NCO functionality of at least 1.8, optionally from 1.8 to 5, and particularly optionally from 2 to 4, and isocyanurates, biurets, allophanates, and uretdiones thereof are suitable as component (a).

Components (b) may be, for example, monoesters of α,β-unsaturated carboxylic acids, such as acrylic acid, methacrylic acid, crotonic acid, itaconic acid, fumaric acid, maleic acid, acrylamidoglycolic acid or methacrylamidoglycolic acid, or vinyl ethers with di- or polyols, which preferably have 2 to 20 carbon atoms and at least two hydroxyl groups, such as ethylene glycol, diethylene glycol, triethylene glycol, 1,2-propylene glycol, 1,3-propylene glycol, 1,1-dimethyl-1,2-ethanediol, dipropylene glycol, triethylene glycol, tetraethylene glycol, pentaethylene glycol, tripropylene glycol, 1,4-butanediol, 1,5-pentanediol, neopentylglycol, 1,6-hexanediol, 2-methyl-1,5-pentanediol, 2-ethyl-1,4-butane diol, 1,4-dimethylolcyclohexane, 2,2-bis(4-hydroxycyclohexyl)propane, glycerol, trimethylolethane, trimethylolpropane, trimethylolbutane, pentaerythritol, ditrimethylolpropane, erythritol, sorbitol, poly-THF having a molecular weight of from 162 to 2000, poly-1,3-propanediol having a molecular weight of from 134 to 400 or polyethylene glycol having a molecular weight of from 238 to 458. It is furthermore possible to use esters or amides of (meth)acrylic acid with amino alcohols, e.g. 2-aminoethanol, 2-(methylamino)ethanol, 3-amino-1-propanol, 1-amino-2-propanol or 2-(2-aminoethoxy)ethanol, 2-mercaptoethanol or polyaminoalkanes, such as ethylenediamine or diethylenetriamine, or vinylacetic acid.

Compounds which are suitable as component (c) are those which have at least two groups reactive toward isocyanate, for example —OH, —SH, —NH₂ or —NHR², where R² therein, independently of one another, may be hydrogen, methyl, ethyl, isopropyl, n-propyl, n-butyl, isobutyl, sec-butyl or tert-butyl.

These are preferably diols or polyols, such as hydrocarbondiols having 2 to 20 carbon atoms, e.g. ethylene glycol, 1,2-propanediol, 1,3-propanediol, 1,1-dimethylethane-1,2-diol, 1,6-hexanediol, 1,10-decanediol, bis-(4-hydroxycyclohexane)isopropylidene, tetramethylcyclobutanediol, 1,2-, 1,3- or 1,4-cyclohexanediol, cyclooctanediol, norbornanediol, pinanediol, decalindiol, etc., esters thereof with short-chain dicarboxylic acids, such as adipic acid or cyclohexanedicarboxylic acid, carbonates thereof, prepared by reaction of the diols with phosgene or by transesterification with dialkyl or diaryl carbonates, or aliphatic diamines, such as methylene- and isopropylidenebis(cyclohexylamine), piperazine, 1,2-, 1,3- or 1,4-diaminocyclohexane, 1,2-, 1,3- or 1,4-cyclohexanebis(methylamine), etc., dithiols or polyfunctional alcohols, secondary or primary amino alcohols, such as ethanolamine, diethanolamine, monopropanolamine, dipropanolamine, etc., or thioalcohols, such as thioethylene glycol.

In another aspect of the present technology, the composition contains the one or more highly crosslinkable monomers and the at least one elastic urethane acrylate oligomer in a weight ratio of 20:80 to 80:20, for example 30:70 to 70:30, for example 60:40 to 70:30. With the inclusion of for example carbon black as described in more detail below, the ratio may for example be 65:35 to 75:25, in particular 75:25. Based on the entirety of the composition, the one or more highly crosslinkable monomers may be present in an amount of from 60 to 75 wt %; the at least one elastic urethane acrylate oligomer may be present in an amount of 10 to 80 wt %, for example from 15 to 45 wt %, in particular from 20 to 30 wt %.

In another aspect of the present technology, in addition to the above mentioned highly crosslinkable monomers and elastic oligomers, the composition may have one or more dyes, pigments, or coloring agents. For example, such dyes, pigments, or coloring agents may be used to provide color or to avoid potential discoloration during printing and/or aging of the printed parts. Exemplary dyes, pigments, or coloring agents include carbon black pigment, white pigment and a variety of dyes like cyane, magenta, yellow etc. In particular the composition includes carbon black, for example in an amount of from 0.005 to 0.1% by weight, for example 0.01 to 0.1% by weight, in particular 0.01 to 0.05% by weight, based on the total weight of the composition. In formulations containing pigments, use may be made of one or more dispersants. Such dispersants would be known to an ordinary skilled artisan. For example it may be possible to use EFKA4701. Dispersants may be used in an amount of around 10 to 100 ppm for example 20 to 50 ppm, in particular 20 ppm based on the weight of the total composition.

The compositions may include one or more photoinitiators. Suitable photoinitiators include, but are not limited to, bis(2,4,6-trimethylbenzoyl)-phenylphosphine oxide, 2,4,6-trimethylbenzoylphenyl phosphinate, bis(2,6-dimethoxybenzoyl)-2,4,4-trimethylpentylphosphine oxide, diphenyl(2,4,6-trimethylbenzoyl)phosphine oxide, alpha-hydroxy cyclohexyl phenyl ketone, 2-hydroxy-1-(4-(4-(2-hydroxy-2-methylpropionyl)benzyl)phenyl-2-methylpropan-1-one, 2-hydroxy-2-methyl-1-phenylpropanone, 2-hydroxy-2-methyl-1-(4-isopropylphenyl)propanone, oligo (2-hydroxy-2-methyl-1-(4-(1-methylvinyl)phenyl)propanone, 2-hydroxy-2-methyl-1-(4-dodecylphenyl)propanone, 2-hydroxy-2-methyl-1-[(2-hydroxyethoxy)phenyl]propanone, benzophenone, substituted benzophenones, and mixtures of any two or more thereof. In any embodiments, the one or more photoinitiators may be diphenyl(2,4,6-trimethylbenzoyl)phosphine oxide, ethyl(2,4,6-trimethylbenzoyl)phenylphosphinate, 1-hydroxycyclohexylphenylketone, and combinations of two or more thereof.

In any embodiments, the one or more photoinitiators may be present in an amount of about 0.01 wt. % to about 6.0 wt. % of the total weight of the composition. Suitable amounts of the photoinitiator include, but are not limited to, about 0.01 wt. % to about 6.0 wt. %, about 0.1 wt. % to about 4.0 wt. %, about 0.20 wt. % to about 3.0 wt. %, or about 0.5 wt. % to about 1.0 wt. %, or about 1 to 2 wt %, based on the photopolymerizable composition. In one embodiment, the photoinitiator is present in an amount from 0.25 wt. % to about 2.0 wt. %. In another embodiment, the photoinitiator is present in an amount from 0.5 wt. % to about 1.0 wt. %.

According to any embodiments, solvents may be used to wash a 3D printed part after printing in order to remove uncured residual resin from the surface. Suitable solvents include, but are not limited to, propylene glycol monomethyl ether acetate, tripropylene glycol methyl ether, tripropylene glycol n-butyl ether, propylene glycol methyl ether, propylene glycol phenyl ether, propylene glycol n-butyl ether, propylene glycol diacetate, dipropylene glycol methyl ether, dipropylene glycol n-propyl ether, dipropylene glycol n-butyl ether, dipropylene glycol dimethyl ether, isopropanol and mixtures of two or more thereof and also their mixtures with water.

According to any embodiments, the composition may further include ethylenically functional or non-functional non-urethane oligomers, which may further enhance the mechanical and chemical properties of the composition of the present technology. Suitable non-urethane oligomers include, but are not limited to, epoxy, ethoxylated or propoxylated epoxy resins, polyesters, polyethers, polyketones, and mixtures of two or more thereof.

Applying the composition to obtain the three-dimensional article may include depositing the composition. In any embodiments, the application may include depositing a first layer of the composition and second layer of the composition to the first layer and successive layers thereafter to obtain a 3D article. Such depositing may include one or more methods, including but not limited to, UV inkjet printing, SLA, continuous liquid interface production (CLIP), and DLP. Other applications for the compositions include, but are not limited to, other coating and ink applications for printing, packaging, automotive, furniture, optical fiber, and electronics.

The methods described herein include contacting the layers of the composition with ultraviolet light irradiation to induce curing of the composition. In any embodiments, the contacting includes short wavelength and long wavelength ultraviolet light irradiation. Suitable short wavelength ultraviolet light irradiation includes UV-C or UV-B irradiation. In one embodiment, the short wavelength ultraviolet light irradiation is UV-C light. Suitable longwave ultraviolet light irradiation includes UV-A irradiation. Additionally, Electron Beam (EB) irradiation may be utilized to induce curing of the composition.

The methods described herein include repeating the deposition of layers of the composition and exposure to UV irradiation to obtain the 3D article. In any embodiments, the repeating may occur sequentially wherein depositing the layers of composition is repeated to obtain the 3D article prior to exposure to UV irradiation. In any embodiments, the repeating may occur subsequently wherein the deposing the layers of composition and exposure to UV irradiation are repeated after both steps.

In another related aspect, a 3D article is provided that includes UV cured successive layers of the any of the compositions as described herein. In any embodiments, the composition may have been inkjet, SLA, or DLP deposited.

In any embodiments, the 3D article may include a polishing pad or similar post processing technique. In any embodiments, polishing pad is a chemical mechanical polishing (CMP) pad. Polishing pads may be made following any known methods, for example the methods provided in U.S. Patent Appl. No. 2016/0107381, U.S. Patent Appl. No. 2016/0101500, and U.S. Pat. No. 10,029,405 (each incorporated herein by reference).

The 3D article of the present technology exhibits improved toughness. In any embodiments, the three-dimensional article may, for example, exhibit a tensile strength of 56 to 81 MPa, or optionally 26 to 55 MPa. The three-dimensional article may optionally have an impact strength of unnotched samples of 10 to 50 kJ/m², for example 20 to 40 kJ/m² or optionally 25 to 40 kJ/m².

The present technology, thus generally described, will be understood more readily by reference to the following examples, which are provided by way of illustration and are not intended to be limiting of the present invention.

### EXAMPLES

### A. Monomer Evaluation

In a study to perform an initial evaluation of potential monomers, the following materials were used:

TABLE 1
Materials used in this study and their properties.

| Material | Function | Functionality | Properties |
|---|---|---|---|
| M1 | High Tg | 2 | Tg 180-190 C. (DMA), |
| | monomer | | Viscocity 400 cPs @ 25 C. |
| M2 | High Tg | 6 | Tg 145 C. (DSC) |
| | monomer | | Viscocity 350 cP @ 25 C. |
| M3 | High Tg | 2.4 | Viscocity 3-6 Pa*s @ 23 C. |
| | monomer | | |
| O1 | Oligomer | 2 | |
| O2 | Oligomer | 2 | Tg −51.6 C. |
| | | | Viscocity 100-130 Pa*s @ 23 |
| | | | C. |
| | | | MW 4000 |
| O3 | Oligomer | 2 | Tg −48.7 C. |
| | | | Viscocity 18-24 Pa*s |
| 2,4,6- | Photo | | |
| Trimethylbenzoyl- | initiator (PI) | | |
| diphenylphosphine | | | |
| oxide | | | |
| Isopropyl Alcohol | Cleaning | | |
| (IPA) | Solvent | | |

### A.1 Compositions

TABLE 2
Wt. % compositions of eighteen formulations prepared and tested in this study.

| Sample # | M1, wt % | M3, wt % | M2, wt % | O1, wt % | O3, wt % | O2, wt % | **PI, % |
|---|---|---|---|---|---|---|---|
| A-1 | 60 | | | | | 40 | 0.96 |
| A-2 | 60 | | | | 40 | | 0.96 |
| A-3 | 60 | | | 40 | | | 0.96 |
| A-4 | 50 | | | | | 50 | 0.8 |
| A-5 | 50 | | | | 50 | | 0.8 |
| A-6 | 50 | | | 50 | | | 0.8 |
| A-7 | | 60 | | | | 40 | 0.96 |
| A-8 | | 60 | | | 40 | | 0.96 |
| A-9 | | 60 | | 40 | | | 0.96 |
| A-10 | | 50 | | | | 50 | 0.8 |
| A-11 | | 50 | | | 50 | | 0.8 |
| A-12 | | 50 | | 50 | | | 0.8 |
| A-13 | | | 60 | | | 40 | 0.96 |
| A-14 | | | 60 | | 40 | | 0.96 |
| A-15 | | | 60 | 40 | | | 0.96 |
| A-16 | | | 50 | | | 50 | 0.8 |
| A-17 | | | 50 | | 50 | | 0.8 |
| A-18 | | | 50 | 50 | | | 0.8 |

Eighteen different formulations were prepared using components listed in Table 1 and mixed in ratios and combinations shown in Table 2.

Typically, 50 or 60 wt % of PI/monomer solution was mixed with 50 or 40% of corresponding oligomer and the photoinitiator as indicated in Table 2. The samples were thoroughly mixed with the help of the Flacktek high speed mixer for 2-3 min followed by sonication in a VWR Ultrasonic bath for 60 min heated up to 50° C. The cycle was repeated as many times as necessary and typically took up to 3 days to ensure blending and dissolution of the photo initiator. The resins were used to print test bars.

### A.2 3D Printing and Post Cure

All 3D printing was performed using an Origin printer operating at 295 mA current and 8.2-8.5 mW/cm² intensity settings. Each 100 μm layer was printed using 3 sec UV exposure time. 3D printed dog bones, impact and DMA bars, as shown in Table 3, were printed in vertical orientation, as a part of a single print. Freshly printed parts were removed from the printing platform, wiped to remove some of the residual liquids off the surface, cleaned with the cleaning solvent and air dried.

Post cure was conducted on all freshly cleaned 3D printed bars by placing them in a CCW UV post cure chamber and radiating with 405 nm UV light and 23-26 mW/cm² power intensity for 2 min on each side. Post cured bars were subsequently tested for mechanical performance.

TABLE 3
Test bar dimensions for different test methods in this study.

| Bars | Dimensions, testing |
|---|---|
| [symbol] | DOG BONES for Tensile testing |
| | 63.5 mm × 9.5 mm × 3.2 mm (ca. 3 mm × 3 |
| | mm neck) |
| | Printed vertically in z-direction |
| [symbol] | IMPACT BARS |
| | 63.5 mm × 12.7 mm × 3.2 mm |
| | Printed vertically in z-direction |
| [symbol] | DMA BARS for HDT testing |
| | 55 mm × 5 mm × 4 mm |
| | Printed vertically in z-direction |
| [symbol] | ASTM D648 HDT BARS |
| | 127 mm × 13 mm × 3-13 mm (4 mm) |

Elongation at break, E Modulus and Tensile strength were measured using an Instron 5965 tensile testing machine and up to seven 3D printed dog bone bars per ASTM D638 V standard. The average values and standard deviations are reported below. Impact strength (Izod ASTM D256) of the 3D printed specimens was measured using Instron IZOD Impact Tester, CEAST 9050. Typically, seven 3D printed bars were tested; the average values and standard deviations are reported. Impact is a measure of a material's toughness and depends on the material's ability to absorb energy during plastic deformation. Impact strength is measured and reported in terms of energy loss per unit of cross-section area (kJ/m2). All impact strength results refer to unnotched samples.

Heat deflection temperature of the 3D printed bars was assessed using DMA three-point bend test method in a manner similar to ASTM D648 (A). Carried in the air atmosphere, the DMA controlled force yielding deformation to the sample to the same strain as if induced in the sample at the load of 0.46 MPa and a temperature ramp of 2C/min were applied during the test. The HDT value reported was the temperature at which the bar deflects 0.25 mm.

### A.3 Results

To avoid producing materials with high flexibility and low tensile strength, the content of flexible oligomer in the formulation was limited to below 50%. To avoid making brittle materials, the high Tg monomer content was kept below 60%. Therefore, 18 formulations comprising of preselected components and above-mentioned compositions were made for the screening study as listed in Table 2. Their measured physical properties are summarized in Table 4.

TABLE 4
Physical properties (average values and standard deviations) of the formulations measured on 3D printed test bars.

| | | | | | | | | Impact | |
|---|---|---|---|---|---|---|---|---|---|
| | | | | | | | Impact | Strength | |
| | | E | Max | | | | Strength | St Dev, | |
| | E | Modulus | Tensile | Tensile | | Elongation | kJ/m2 | kJ/m2 | Softening |
| Sample | Modulus, | St Dev, | Strength, | Strength St | Elongation | @ break, St | w/o | w/o | Temp, |
| # | MPa | MPa | MPa | Dev, MPa | @ break, % | dev, % | notch | notch | C. |
| A-1 | 2248 | 68 | 66 | 4.4 | 3.9 | 0.3 | 24 | 11 | 58.9 |
| A-2 | 2579 | 86 | 87 | 4.1 | 4.4 | 0.3 | 20 | 6 | 63.7 |
| A-3 | 2985 | 91 | 49 | 7.2 | 2.2 | 0.4 | 5 | 0.8 | 139.3 |
| A-4 | 1701 | 52 | 54 | 1 | 5.1 | 0.4 | 44 | 13 | 51.6 |
| A-5 | 2436 | 57 | 84 | 0.9 | 4.6 | 0.2 | 34 | 7 | 51.1 |
| A-6 | 2678 | 129 | 40 | 5.5 | 1.9 | 0.3 | 6.5 | 1 | 97.4 |
| A-7 | 1293 | 39 | 41 | 0.8 | 7.8 | 1.6 | 58 | 18 | 36.2 |
| A-8 | 2195 | 26 | 67 | 0.6 | 7.0 | 2.1 | 58 | 12 | 39.1 |
| A-9 | 1990 | 114 | 46 | 12.3 | 3.4 | 1.1 | 21 | 8 | 48 |
| A-10 | 867 | 19 | 33 | 1 | 12.9 | 2.2 | 75 | 19 | 35.5 |
| A-11 | 1891 | 42 | 58 | 0.67 | 6.4 | 1.6 | 42 | 7 | 35.3 |
| A-12 | 1771 | 74 | 46 | 7.4 | 4.2 | 1.0 | 12.6 | 4 | 46.1 |
| A-13 | 2520 | 196 | 57 | 12.9 | 3.3 | 0.4 | 14.8 | 5 | 86.2 |
| A-14 | 3114 | 76 | 77 | 11.2 | 5.6 | 3.0 | 14.6 | 2 | 268 |
| A-15 | 3534 | 174 | 42 | 8.9 | 2 | 0.3 | 8.2 | 3 | 197 |
| A-16 | 1910 | 35 | 54 | 2.3 | 4 | 0.3 | 21 | 9 | * |
| A-17 | 2790 | 73 | 86 | 4.3 | 4.2 | 0.4 | 24 | 5 | 65.7 |
| A-18 | 2943 | 102 | 46 | 10.7 | 2.4 | 0.4 | 6.7 | 2 | 147 |

Finally, the HIDT property of the Sample 14 resin was validated according to ASTM D648 test method, yielding a result of 253.6 C. This result is in agreement with DMA softening point measurement of 268C and confirms unique thermal stability of this material.

### B. Further Testing and Formulation Examples

The goal of this study was to improve on the mechanical properties of the formulations discussed above, while maintaining a reasonably high HDT value. In the process of selecting and developing new formulation 11 different high Tg crosslinkable monomers were evaluated. Furthermore, 60/40 blends of monomers with O3 oligomers were prepared to further identify the proper formulation. Table 5 below identifies the materials used in this example.

TABLE 5
Materials used in this study and their reported properties.

| Material/Designation | Designation | Function | Functionality |
|---|---|---|---|
| Urethane acrylate | M2 | High Tg monomer | 6 |
| Ethoxylated pentaerythritol | M3 | High Tg monomer | 4 |
| tetraacrylate | | | |
| Ethoxylated trimethylpropane | M4 | High Tg monomer | 3 |
| triacylate | | | |
| Polyether acrylate containing SiO2 | M5 | High Tg monomer | 1.5 |
| nanoparticles | | | |
| Dipropylane glycol diacrylate | M6 | High Tg monomer | 2 |
| Propoxylated glycerol triacrylate | M7 | High Tg monomer | 3 |
| Propoxylated neopentyl glycol | M8 | High Tg monomer | 2 |
| diacrylate | | | |
| Tripropylene glycol diacrylate | M9 | High Tg monomer | 2 |
| Trimethylolpropane triacrylate | M10 | High Tg monomer | 3 |
| Tricyclodecanedimethanol | M11 | High Tg monomer | 2 |
| diacrylate | | | |
| Ethoxylated pentaerythritol | M12 | High Tg monomer | 4 |
| tetraacrylate | | | |
| Tricyclodecanedimethanol | M11 + | High Tg monomer | 2 |
| containing Silica nano particles | Silica | | |
| | nanoparticles | | |
| Ethoxylated Tetra Acrylate | M12 + | High Tg monomer | 4 |
| containing Silica nano particles | Silica | | |
| | nanoparticles | | |
| Polyurethane acrylate | O3 | Oligomer | 2 |
| 2,4,6-Trimethylbenzoyl- | | Photo initiator (PI) | |
| diphenylphosphine oxide | | | |
| Isopropyl Alcohol (IPA) | | Cleaning Solvent | |

Eleven monomers of high functionality of 2 and above were selected due to their ability to form high Tg chains and crosslinked networks. O3 polyurethane diacrylate oligomer (made from beta-hydroxyethyl acrylate, epsilon caprolactone and dicyclohexylmethane-4,4′-diisocyanate) was introduced to impart toughness and to control crosslink density.

### B.1 Preparation of UV Curable Formulations

For pure monomers, 10% PI and 99% of pure monomer were mixed together using Flacktek high speed mixer for 2-3 min followed by sonication in a VWR Ultrasonic bath for 60 min heated up to 50° C. The cycle was repeated as many times as necessary and typically took up to 3 days to ensure blending and dissolution of the photo initiator.

For monomer/oligomer formulations, typically, a 1% PI was dissolved in Monomer/O3 blend pre-mixed in the desired ratio. Each sample was mixed using Flacktek high speed mixer for 2-3 min followed by sonication in a VWR Ultrasonic bath for 60 min heated up to 50° C. The cycle was repeated as many times as necessary and typically took up to 3 days to ensure blending and dissolution of the photo initiator. All samples were freshly mixed with the help of Flacktek mixer prior to being used for 3D printing.

B.2 3D Printing and Post Cure All 3D printing has been performed using an Origin printer operating at 295 mA current and 8.2-8.5 mW/cm² intensity settings. Each 100 μm layer was printed using 3 sec UV exposure time, unless otherwise mentioned. 3D printed dog bones, impact and DMA bars, as shown in Table 3 above, were printed in vertical orientation, as a part of a single print. Freshly printed parts were removed from the printing platform, wiped to remove residual liquids off the surface, cleaned with the cleaning solvent and air dried. A detailed 3D printing study was conducted on the same Origin printer by varying the thickness of the printing layers (50-200 μm) and by changing the UV exposure time in each layer (0.5-3.5 sec). With the focus on 100 μm layer thickness and 1.25 sec or 1.5 sec UV exposure.

Post cure was conducted on all freshly cleaned 3D printed bars by placing them in a CCW UV post cure chamber and radiating with 405 nm UV light and 23-26 mW/cm² power intensity for 2 min on each side. Post cured bars were subsequently tested for mechanical performance.

### B.3 Mechanical Testing

Elongation at break (referred to as Elongation throughout the report), E Modulus and Tensile strength were measured using Instron 5965 tensile testing machine and up to seven 3D printed dog bone bars per ASTMD638 V standard. The average values and standard deviations are reported in this study.

Impact strength of the 3D printed specimens was measured using Instron IZOD Impact Tester, CEAST 9050. Typically, seven 3D printed bars were tested; the average values and standard deviations are reported. The impact strength is measured and reported in terms of energy loss per unit of cross-section area (kJ/m2) and energy loss per unit of thickness (J/m). Due to cracks formation upon notching, notching was avoided; all samples were tested unnotched.

Heat deflection property (or a softening temperature) of the 3D printed bars was assessed using the same DMA three-point bend test method described above. Carried in the air atmosphere, the DMA controlled force yielding deformation to the sample to the same strain as if induced in the sample at the load of 0.46 MPa and a temperature ramp of 2° C./min were applied during the test. The HDT value reported was the temperature at which the bar deflects 0.25 mm.

An HDT test was performed using a CEAST automated Instrument using ASTM-D648 test method corresponding to the applied Load of 455 KPa (66 psi). The test was done in a controlled environment room: all samples were conditioned at 23° C. and 52% relative humidity for 24 hours prior to testing. Silicon Oil was used as a heating medium in the instrument to heat the samples from the starting temperature of 23C with the heating rate of 120° C./hr. Two or three replicate samples were measured for each material tested to calculate the average value reported here.

### B.3 Results

3D printed test bars made of selected individual monomers containing only 1% photo initiator were produced and subsequently analyzed. The test bars were tested for physical properties, the results of which are shown in Table 6.

TABLE 6
Physical properties (average values and standard deviations)
of the formulations consisting of pure monomers and 1% TPO
photoinitiator as evaluated by testing 3D printed specimens.

| | Tensile | | | | |
|---|---|---|---|---|---|
| | E Modulus, | Elongation @ | Impact Strength w/o notch | | HDT, Softening |
| Monomer | MPa | break (%) | kJ/m2 | J/m | Temp, C. |
| M2 | 4150 ± 150 | 1.1 ± 0.3 | 8.1 ± 2.3 | 103 ± 30 | 288 |
| M3 | 2250 ± 185 | 1.8 ± 0.3 | 12.1 ± 6.2 | 155 ± 79 | 161 |
| M4 | 2150 ± 80 | 1.9 ± 0.3 | 7.7 ± 3.7 | 98 ± 47 | 91 |
| M5 | 4100 ± 150 | 1.2 ± 0.2 | 3.3 ± 0.2 | 43 ± 2.4 | 100 |
| M6 | 2650 ± 80 | 2.7 ± 0.5 | 15.7 ± 7.3 | 198 ± 93 | 73 |
| M7 | 2100 ± 40 | 1.7 ± 0.3 | 4.5 ± 2.0 | 56 ± 25 | 50 |
| M8 | 1500 ± 60 | 2.4 ± 0.2 | 2.5 ± 0.7 | 31.6 ± 9.1 | 39 |
| M9 | 2050 ± 60 | 2.5 ± 0.2 | 6.4 ± 1.2 | 81 ± 15 | 47 |
| M10 | prints cracked bars, bars further crack in the ultrasound bath | | | | N/A |
| M11 | 2800 ± 70 | 3.2 ± 0.7 | 11.4 ± 2.8 | 145 ± 36 | 89 |
| M12 | 2400 ± 160 | 2.0 ± 0.3 | 10.3 ± 6.4 | 132 ± 81 | 90 |

* All printed bars have cracks that further propagate and break during ultrasonic wash.

The results in Table 6 show that, in its pure state, M2 cures during the 3D printing to form a strong material with exceptionally high E Modulus 4150 MPa, high HDT 288° C., very low elongation at break and impact strength 1.10 and 8.1 kJ/m², respectively. This performance corresponds to a strong, thermally stable and fragile material.

### B.4 Monomer/Oligomer Photocurable Formulations

In this example a high Tg component (a monomer from Table 6) and an elastic oligomer (O3) blended to formulate a UV curable acrylic based material. For the purpose of this study, the monomer type was varied while the oligomer component was kept constant. The ratio between the two components remained constant throughout this example.

TABLE 7
Physical properties (average values and standard deviations)
of the monomer/O3 formulations containing 1% photoinitiator
as measured on 3D printed test bars.

| | | | | Impact |
|---|---|---|---|---|
| | | Tensile | | Strength |
| | | E Modulus, | Elongation | (unnotched) |
| Sample | Monomer | MPa | @ break (%) | kJ/m2 |
| B-1 | M2 | 3100 ± 150 | 3.5 ± 0.6 | 15 ± 2.5 |
| B-2 | M3 | 1800 ± 20 | 5.8 ± 0.8 | 33 ± 10 |
| B-3 | M4 | 1650 ± 100 | 5.9 ± 1.7 | 50 ± 17 |
| B-4 | M5 | 1900 ± 130 | 4.9 ± 0.9 | 30 ± 5 |
| B-5 | M6 | 2200 ± 30 | 4.9 ± 0.8 | 39 ± 10 |
| B-6 | M7 | 1450 ± 40 | 8.3 ± 1.3 | 47 ± 11 |
| B-7 | M8 | 1000 ± 30 | 13 ± 1.0 | 62 ± 14 |
| B-8 | M9 | 1550 ± 30 | 7.3 ± 1.2 | 50 ± 9 |
| B-9 | M10 | 2600 ± 50 | 3.4 ± 0.4 | 16 ± 5 |
| B-10 | M11 | 2450 ± 100 | 4.6 ± 0.2 | 38 ± 10 |
| B-11 | M12 | 2000 ± 80 | 5.7 ± 0.6 | 25 ± 5 |
| B-12 | M11 + Silica | 3000 ± 90 | 2.7 ± 0.4 | 9 ± 4 |
| B-13 | M14 + Silica | 2400 ± 50 | 3.3 ± 0.3 | 13 ± 2 |

### B5. M3/O3 Formulations

The properties of a M3/O3 formulation were evaluated based on compositions ranging from 75/25 to 50/50. Table 8 shows the properties obtained for M3/O2 systems compared with Sample 14 and pure M3, O3 and M2 components. The results are given in Table 8 below.

TABLE 8
Physical properties (average values and standard deviations) of the M3/O3 formulations
(Samples B-21-B25), Sample 14 and pure ingredients (O3, M3 and M2) measured
on 3D printed test bars. All formulations contain 1% photoinitiator.

| | | | | | HDT |
|---|---|---|---|---|---|
| | | | Impact | | (Softening |
| Sample | E Modulus, | Elongation | Strength, | Impact | Temperature) |
| designation | MPa | @ break (%) | kJ/m2 | Strength, J/m | C. |
| O3 | 566 ± 48 | 32.9 ± 3.6 | 124 ± 6.8 | 1589 ± 89 | 25.8 |
| M3 | 2229 ± 185 | 1.8 ± 0.3 | 12.1 ± 6.2 | 155 ± 79 | 161.7 |
| M2 | 4130 ± 151 | 1.1 ± 0.3 | 8.1 ± 2.3 | 103 ± 30 | 288 |
| Sample 14 | 3093 ± 143 | 3.45 ± 0.6 | 15.3 ± 2.3 | 196 ± 29 | 272.4 |
| Sample B-21 | 1891 ± 37 | 4.7 ± 0.3 | 19.5 ± 4.6 | 248 ± 59 | 181.7 |
| Sample B-22 | 2009 ± 51 | 5.3 ± 0.8 | 23.2 ± 9.0 | 297 ± 115 | 60.8 |
| Sample B-23 | 1865 ± 43 | 5.5 ± 1.0 | 28.8 ± 9.6 | 367 ± 122 | 50 |
| Sample B-24 | 1776 ± 29 | 5.8 ± 0.8 | 33 ± 9.8 | 422 ± 125 | 47.6 |
| Sample B-25 | 1659 ± 30 | 7.7 ± 1.7 | 49.7 ± 13.2 | 633 ± 168 | 41.6 |

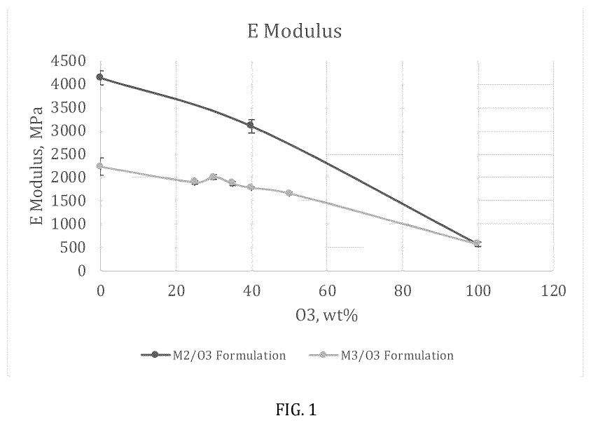

The data from Table 8 are plotted in FIGS. 1 to 3. FIG. 1 depicts E Modulus as a function of oligomer O3 content. The dark grey trace corresponds to M2/O3 formulation and connects E Modulus values of pure individual components, i.e. M2 and 03. The light grey curve connects all the M3/O3 compositions and pure components; the whole curve is shifted downwards and shows linear decline of E Modulus in a wide range of O3 compositions (25-50%). Overall, E Modulus shows linear dependence on the composition of the formulation.

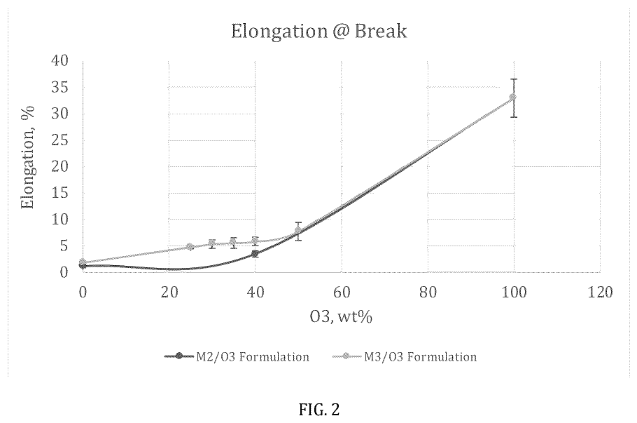

FIG. 2 presents Elongation at break as a function of O3 content in the formulations. The dark grey trace for M2/O3 system, shows very low elongation indicative of highly crosslinked and rigid system. A higher elongation is observed for M3/O3 formulations (light grey symbols). A wide range of oligomer compositions (25-50%) yields narrow range of elongation observed in the 3D printed samples, 4-8%.

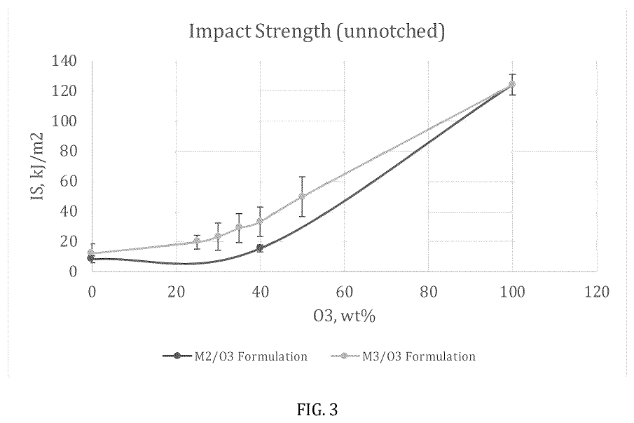

The analysis of impact data (FIG. 3) is very similar to that of Elongation data (FIG. 2). The M3/O3 formulation appear to have higher impact strength and higher elongation characteristics, indicative of improved toughness.

### C. Compositions Including Carbon Black

Potential effect of the addition of carbon black was studied by doping Formulations B-21 and B-22 with different amounts of Carbon Black pigment in the amount of less than 1%. The properties of the respective 3D printed materials are shown in Table 9.

TABLE 9
Properties of the M3/O3 formulations B-21 and B-22
containing different amounts of Carbon Black.

| | Carbon | | | | | Softening |
|---|---|---|---|---|---|---|
| Sample | Black, | E Modulus, | Elongation @ | Impact Strength (IS) | | Point |
| designation | ppm | MPa | break (%) | kJ/m2 | StDev | (DMA), C. |
| B-22 | 500 | 1281 | 5.2 | 28.6 | 9.4 | 46 |
| B-22 | 334 | 1337 | 5.4 | 23.4 | 15.4 | 48.5 |
| B-22 | 300 | 1411 | 4.6 | 28.3 | 3.7 | 53.1 |
| B-22 | 240 | 1557 | 5.6 | 29.3 | 12.9 | |
| B-22 | 200 | 1509 | 5.5 | 27.6 | 12.6 | 57.9 |
| B-22 | 150 | 1734 | 5.2 | 24.6 | 7.1 | 59.2 |
| B-22 | 100 | 1829 | 5.3 | 26.4 | 7.9 | 54.8 |
| B-22 | 0 | 2009 | 5.3 | 23.2 | 9 | 60.8 |
| B-21 | 334 | 1369 | 4.8 | 25.5 | 8.1 | |
| B-21 | 100 | 1784 | 4.7 | 25.3 | 4.2 | |
| B-21 | 0 | 1891 | 4.7 | 19.5 | 4.6 | 73.7 |

The data in Table 9 show that E Modulus decreases with increased amount of carbon black in the formulation. The Impact strength increases with augmentation of Carbon Black. The Elongation remains unchanged with increase amounts of Carbon Black below 1 wt %. The optimum amount of pigment is dictated by application where darker colors and tinted parts are preferred and where the balance of various properties has to be considered and achieved.

The results presented here demonstrate that, by selection of highly crosslinkable monomers and elastic urethane acrylate oligomers as described herein it was possible to achieve the desired HDT values, while maintaining reasonably strong mechanical characteristics.

Preferred embodiments of this invention are described herein, including the best mode known to the inventors for carrying out the invention. It will be appreciated that the invention is not restricted to the details described above with reference to the preferred embodiments but that numerous modifications and variations can be made without departing from the spirit and scope of the invention as defined by the following claims.

What is claimed is:

1) A photopolymerizable composition comprising:
at least one highly crosslinkable acrylate monomer with a functionality of 3 or higher;
at least one elastic urethane acrylate oligomer; and
at least one photoinitiator.

2) The photopolymerizable composition according to claim 1, wherein the at least one highly crosslinkable acrylate monomer is an acrylate monomer according to Formula I: 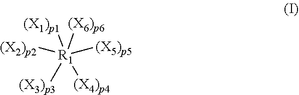
wherein R₁ is a branched or linear hydrocarbon chain with carbon, ether, ester or urethane linkages; each of X₁, X₂, X₃, X₄, X₅, and X₆ is independently an acryl moiety, and each of p₁, p₂, p₃, p₄, p₅, and p₆ is independently 0 or 1; wherein the sum of p₁, p₂, p₃, p₄, p₅, and p₆ is a value of from 3 to 6.

3) The photopolymerizable composition according to claim 2, wherein the sum of p₁, p₂, p₃, p₄, p₅, and p₆ is a value of from 4 to 5.

4) The photopolymerizable composition according to claim 1, wherein the at least one highly crosslinkable acrylate monomer is an acrylate monomer according to Formula II: 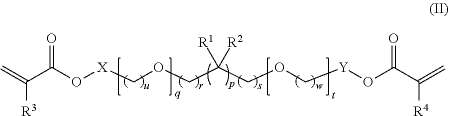
wherein R¹ and R² are each independently H, C₁₋₆ alkyl, or 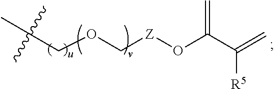
wherein at least one R¹ or R² is 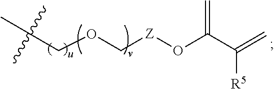
R³, R⁴, and R⁵ are each independently H or CH₃;
X, Y, and Z are independently absent or a C₁-C₆ alkylene group;
p is 0 or 1;
w at each occurrences is independently 1, 2, or 3;
q is 0 or an integer from 1-100;
t is 0 or an integer from 1-100;
r, s, u, and v are independently 0, 1, 2, 3, or 4.

5) The photopolymerizable composition according to claim 4 wherein both R¹ and R² are

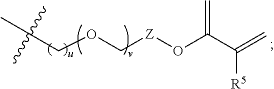

6) The photopolymerizable composition according to claim 1, wherein the at least one highly crosslinkable acrylate monomer is selected from the group consisting of:
ethoxylated pentaerythritol tetraacrylate 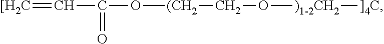
ethoxylated trimethyl propane triacrylate 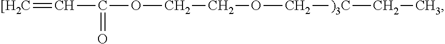
propoxylated glycerol triacrylate

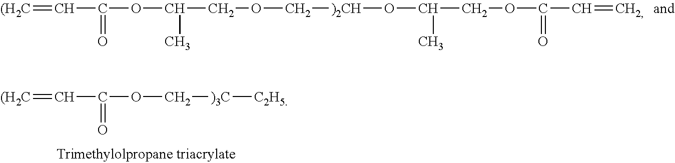

7) The photopolymerizable composition according to claim 6, wherein the highly crosslinkable acrylate monomer is ethoxylated pentaerythritol tetraacrylate.

8) The photopolymerizable composition according to claim 1, wherein the elastic urethane acrylate oligomer is a urethane(meth)acrylate of formula (III) 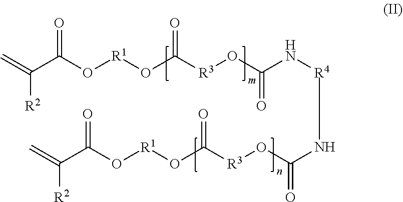
wherein:
R¹ is a divalent alkylene radical which has 2 to 12 carbon atoms and which may optionally be substituted by C₁ to C₄ alkyl groups and/or interrupted by one or more oxygen atoms, said radical specifically having 2 to 10 carbon atoms, more specifically 2 to 8, and very specifically having 3 to 6 carbon atoms,
R² in each case independently of any other is methyl or hydrogen, specifically hydrogen,
R³ is a divalent alkylene radical which has 1 to 12 carbon atoms and which may optionally be substituted by C₁ to C₄ alkyl groups and/or interrupted by one or more oxygen atoms, said radical having specifically 2 to 10, more specifically 3 to 8, and very specifically 3 to 4 carbon atoms, and
n and m independently of one another are positive numbers from 1 to 5, specifically 2 to 5, more specifically 2 to 4, very specifically 2 to 3, and more particularly 2 to 2.5.
R⁴ here is a divalent organic radical which is formed by abstraction of both isocyanate groups from an aliphatic, cycloaliphatic or aromatic diisocyanate.

9) The photopolymerizable composition according to claim 8, wherein the urethane acrylate oligomer is obtained by a process comprising:
(I) reacting hydroxyalkl(meth)acrylates (A) of the formula 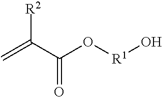
with (n+m)/2 equivalents of lactone (B) of formula 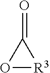
to form an intermediate of formula 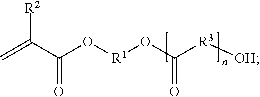
and
(II) reacting the intermediate formed in the first step with at least one aliphatic, cycloaliphatic or aromatic diisocyanate to form the urethane acrylate oligomer.

10) The photopolymerizable composition according to claim 9, wherein the hydroxyalkyl(meth)acrylate (A) is selected from the group consisting of 2-hydroxyethyl(meth)acrylate, 2- or 3-hydroxypropyl(meth)acrylate, 1,4-butanediol mono(meth)acrylate, neopentyl glycol mono(meth)acrylate, 1,5-pentanediol mono(meth)acrylate, and 1,6-hexanediol mono(meth)acrylate, very specifically 2-hydroxyethyl(meth)acrylate, 2-hydroxypropyl(meth)acrylate, and 1,4-butanediol mono(meth)acrylate.

11) The photopolymerizable composition according to claim 10, wherein the hydroxyalkyl(meth)acrylate (A) is hydroxyethyl(meth)acrylate.

12) The photopolymerizable composition according to any claim 9, wherein the lactone (B) is selected from the group consisting of beta-propiolactone, gamma-butyrolactone, gamma-ethyl-gamma-butyrolactone, gamma-valerolactone, delta-valerolactone, epsilon-caprolactone, 7-methyloxepan-2-one, 1,4-dioxepan-5-one, oxacyclotridecan-2-one, and 13-butyl-oxacyclotridecan-2-one.

13) The photopolymerizable composition according to claim 12, wherein the lactone (B) is epsilon-caprolactone.

14) The photopolymerizable composition according to claim 9, wherein the at least one aliphatic, cycloaliphatic or aromatic diisocyanate is dicyclomethane diisocyanate.

15) The photopolymerizable composition according to claim 1, wherein the composition contains the at least one highly crosslinkable acrylate monomer and the at least one elastic urethane acrylate oligomer in a weight ratio of 20:80 to 80:20.

16) The photopolymerizable composition according to claim 1, wherein the composition contains the at least one highly crosslinkable acrylate monomer and the at least one elastic urethane acrylate oligomer in a weight ratio of 30:70 to 70:30.

17) The photopolymerizable composition according to claim 1, wherein the composition contains the at least one highly crosslinkable acrylate monomer and the at least one elastic urethane acrylate oligomer in a weight ratio of 60:40 to 70:30.

18) The photopolymerizable composition according to claim 15, wherein the one or more highly crosslinkable monomers is present in an amount of from 60 to 75 wt %, and the at least one elastic urethane acrylate oligomer is present in an amount of 10 to 40 wt %, both based on the composition as a whole.

19) The photpolymerizable composition according to claim 18, wherein the at least one elastic urethane acrylate oligomer is present in an amount of 20 to 30 wt %

20) The photopolymerizable composition according to claim 1, further comprising carbon black and wherein the weight ratio of the at least one highly crosslinkable acrylate monomer and the at least one elastic urethane acrylate oligomer is in the range of 65:35 to 75:25.

21) The photopolymerizable composition according to claim 1, wherein the composition, after photopolymerization, has a heat deflection temperature of at least 80° C.

22) The photopolymerizable composition according to claim 21, wherein the composition, after photopolymerization, has a heat deflection temperature of at least 150° C.

23) A package comprising the composition of claim 1.

24) A method of preparing a three-dimensional article, wherein the method comprises applying successive layers of one or more of the compositions of claim 1 to fabricate a three-dimensional article, and irradiating the successive layers with UV irradiation.

25) The method of claim 24, wherein the applying comprises depositing a first layer of the composition to a substrate and applying a second layer of the composition to the first layer and optionally applying successive layers thereafter.

26) The method of claim 24, wherein the applying comprises ink jet printing of the composition.

27) The method of claim 24, wherein the three-dimensional article has a heat deflection temperature of at least 100° C.

28) The method of claim 24, wherein the three-dimensional article has a heat deflection temperature of at least 150° C.

29) A three-dimensional article comprising UV cured successive layers of the composition of claim 1.

30) A three-dimensional article produced by the method of claim 24.

31) The three-dimensional article of claim 29, wherein the three dimensional article has a heat deflection temperature of at least 100° C.

32) The three-dimensional article of claim 29, wherein the three dimensional article has a heat deflection temperature of at least 150° C.
